(19) United States
(12) Patent Application Publication
(10) Pub. No.: US 2009/0093981 A1
(43) Pub. Date: Apr. 9, 2009

(54) INTEGRATED TILT COMPENSATED COMPASS IN A SINGLE PACKAGE

(75) Inventor: Lakshman Withanawasam, Maple Grove, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/868,390

(22) Filed: Oct. 5, 2007

(51) Int. Cl. G01C 17/38

(52) U.S. Cl. 702/93; 33/356

(57) ABSTRACT

A magnetic compass includes a magnetic sensor, an acceleration sensor, respective signal conditioning circuits in electronic communication with the sensors and a microprocessor. These components are arranged and structurally coupled to a single electronic package that supports the sensors, the signal conditioning circuits, and the microprocessor to provide a miniaturized magnetic compass. In addition, a temperature sensor may be coupled to the package to provide temperature compensation for at least some of the above-identified components.

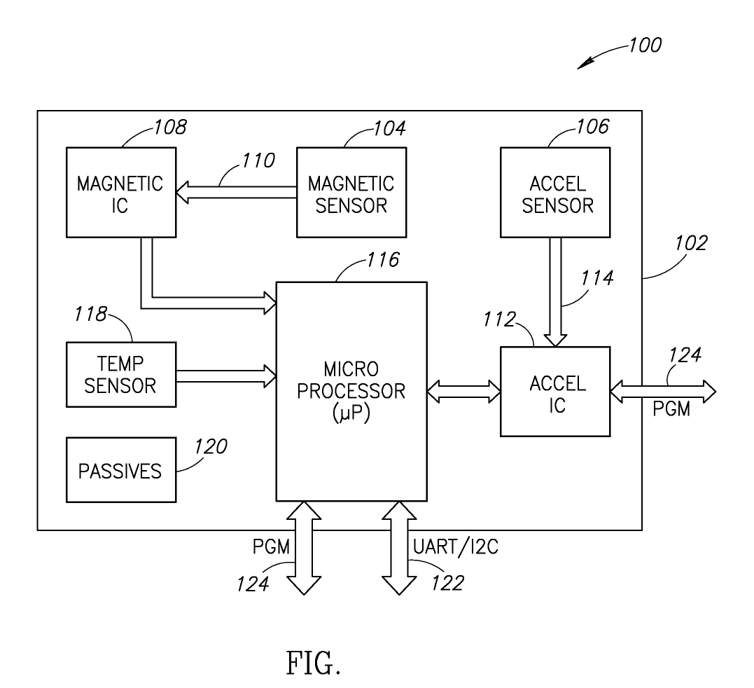

### BACKGROUND OF THE INVENTION

Existing magnetic compasses are typically arranged to include a magnetic sensor and acceleration sensors, but current packaging techniques do not allow the existing compasses to be sufficiently small and yet still meet industry heading performance and accuracy requirements. Conventionally, the magnetic sensor and the acceleration sensors of the existing compasses are arranged in separate electronic packages. In addition, the compasses may include signal conditioning integrated circuits arranged in other separate electronic packages. The various packages are then configured to electronically communicate with one another to carry out the various functions of the compass.

### BRIEF SUMMARY OF THE INVENTION

The present invention provides a magnetic compass located in a single electronic package that is SMT assembly compatible. The magnetic compass includes a magnetic sensor; a first integrated signal conditioning circuit in electronic communication with the magnetic sensor; an acceleration sensor; a second integrated signal conditioning circuit in electronic communication with the acceleration sensor; a microprocessor in electrical communication with the first and second integrated signal conditioning circuits; and a single electronic package configured to structurally support the sensors, the signal conditioning circuits, the microprocessor in an integrated arrangement wherein the sensors, the signal conditioning circuits, and the microprocessor interact to provide signal conditioning and compass computations, and may further include a set of features enabling the integration of the compass to a host device.

In one aspect of the invention, a method of arranging electrical components of a magnetic compass to produce compass-related computations includes structurally attaching a magnetic sensor, an acceleration sensor, and signal conditioning circuits onto a single electronic package; centrally locating and structurally attaching a microprocessor on the package such that the microprocessor is in electrical communication with at least the signal conditioning circuits; detecting a tilt angle of the compass with the acceleration sensor and providing a signal representative of the tilt angle to the microprocessor; detecting a magnetic heading with the magnetic sensor and providing a signal representative of the magnetic heading to the microprocessor; and outputting computations performed with the microprocessor to provide a readable tilt angle and magnetic heading of the compass.

### BRIEF DESCRIPTION OF THE DRAWINGS

Preferred and alternative embodiments of the present invention are described in detail below with reference to the following drawings:

The FIGURE is a hardware block diagram of electronic components of a magnetic compass arranged in a single electronic package, according to an illustrated embodiment of the invention.

### DETAILED DESCRIPTION OF THE PREFERRED EMBODIMENT

In the following description, certain specific details are set forth in order to provide a thorough understanding of various embodiments of the invention. However, one skilled in the art will understand that the invention may be practiced without these details or with various combinations of these details. In other instances, well-known structures and methods associated with magnetic sensors, accelerometers and electronic hardware packaging, to include the operation thereof may not be shown or described in detail to avoid unnecessarily obscuring descriptions of the embodiments of the invention.

The following description is generally directed to a tilt compensated magnetic compass with various sensors, integrated circuits, and at least one microprocessor integrated into a single electronic package and operable to enable an array of applications, such as but not limited to Location Based Services and Geo Physical Information data. An electronic package is generally understood to be the bundles of circuits, connections and bonds and the arrangement thereof within an electronic device.

Aspects of the invention are generally related to various features of a magnetic compass and the integration of those features in a single electronics package. Preferably, the magnetic compass is a fully integrated, tilt compensated compass having a magnetic sensor, a three-axis acceleration sensor to detect tilt, a temperature sensor for temperature compensation, signal conditioning integrated circuits (ICs) to condition the signals from the sensors, and a microprocessor to perform digital signal processing and compass computations. All the above-described electronic components are arranged in a single electronic package arranged on a single laminate, which makes the overall electronic package sufficiently small, yet cost effective to assemble. In one embodiment, the magnetic compass primarily provides a computed directional heading and a tilt angle with respect to a desired reference plane. Before operation, the various sensors may be individually calibrated and then during operation the temperature sensor may operate to provide temperature compensation for the sensor to achieve accurate results.

The FIGURE shows a block diagram of a magnetic compass 100 having components structurally coupled to and arranged in a single electronic package 102 according to an embodiment of the invention. By way of example, the single electronic package 102 may be a single piece of plastic, silicon, or equivalent material onto which conventionally a single sensor, processor, or integrated chip would be mounted. In one embodiment, the single electronic package 102 is a flexible, laminate that permits the overall area of the package 102 to be about 9 mm×9 mm or smaller.

In the illustrated embodiment, the single electronic package 102 structurally supports and provides an integrated connection platform for a magnetic sensor 104, an acceleration sensor 106, a first signal processing integrated circuit 108 configured to electronically communicate and process magnetic signals 110 from the magnetic sensor 104, a second signal processing integrated circuit 112 configured to electronically communicate and process accelerometer signals 114 from the acceleration sensor 106. In one embodiment, one or both of the first and second signal processing integrated circuits 108, 112 are active, application-specific integrated circuits (ASICs) customized for conditioning the respective signals 110, 114 from the respective sensors 104, 106.

In addition to the above-identified components, a microprocessor 116 is structurally coupled to the package 102 and arranged to be in signal communication with the first and second signal processing integrated circuits 108, 112. Preferably, the microprocessor 116 is centrally located on the package 102 to minimize the footprint of the package 102. In a preferred embodiment, the microprocessor 116 operates to perform compass computations such as providing a compass heading accurate within a range of about 0.5-2.0 degrees. By way of example, the heading accuracy is enabled by having all the sensors in a single package that can be calibrated as a single unit to achieve more coherent data, specifically, the coordinate systems of the magnetic, accelerometer and the electronic package are made co-linear. Further and by way of example, the microprocessor 116 may perform digitization of the sensor signals, digital signal conditioning and compensation, computation of compass heading, compass attitude, and communication.

A temperature sensor 118 is also structurally coupled to the package 102 and arranged to be in signal communication with the microprocessor 116. The temperature sensor 118 operates to provide at least some amount of temperature compensation for the sensors 104, 106, the circuits 108, 112, the microprocessor 116, or some combination thereof during operation of the magnetic compass 100 The microprocessor 116 monitors the temperature of the package with the temperature sensor 118, and compensates the magnetic and acceleration sensors' offsets and scale factors. Other forms of temperature compensation without the microprocessor 116 may be possible as well.

In addition to the aforementioned features and components, the magnetic compass 100 may include at least one passive component 120 that may, for instance, a capacitor that constitutes a passive filter for a signal, or a resistor that limits the current draw from the application (host) power supply.

The electronic package 102 may incorporate a number of different types of data communication devices or ports 122 in which one or more integrated circuit 108, 112 and/or the microprocessor 116 communicates or interfaces with an external serial device. One such data communication device may be a Universal Asynchronous Receiver/Transmitter (UART) having a program or module for controlling data transfer between the microprocessor 116 and a serial device located external to the single package 102. For example, the UART may provide the microprocessor 116 with a RS-232C Data Terminal Equipment (DTE) interface so that the microprocessor 116 may communicate with and/or exchange data with modems and other serial devices.

In addition, a pragmatic general multicast (PGM) port that allows at least some of the components located on the package 102 to communicate with a programmer to program the compass.

The single package 102 may be further configured for communication with various hardware and software devices, to include but not limited to an inter-integrated circuit (I2C) bus, a serial peripheral interface (SPI) bus, and a UART. In addition, the arrangement of the sensors 104, 106, the signal conditioning integrated circuits 108, 112, the microprocessor 116, and the temperature sensor 118 may enhance the functionality of the compass 100 by providing dead-reckoning, user defined compass orientation for a variety of possible mechanical mounting to the host, fully automated field or user calibration to compensate for the magnetic disturbances invariably present in any host system, a post assembly accelerometer compensation method to correct the shifts that invariably most accelerometers undergo during SMT assembly process, and a user selectable acceleration range to allow the compass to be customized to the needs of the application.

Advantageously, the single electronic package 102 integrates a magnetic sensor and an accelerometer, permits sensor calibrations to be performed at a factory, and provides a user with the benefit of a plug-and-play tilt compensated magnetic compass in a single package. The compass may be calibrated to provide accurate heading and tilt data before the compass leaves the factory. This eliminates the need to calibrate the sensors at the host application level and leads to plug and play. Also, it is plug and play since the device may transmit sensor compensated, fully calibrated heading output as oppose to raw sensor data or uncompensated heading data. Further, the various components of the compass 100 may be integrated and structurally coupled to the electronic package 102 via surface mount technologies (SMT), wire bonding, flip chip, stacked die or other integrated circuit assembly techniques. Because the magnetic compass 100 outputs a temperature compensated compass heading, the user does not have to perform heading computations, compensations, or similar steps when operating the compass 100.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A magnetic compass comprising:
a magnetic sensor;
a first signal conditioning circuit in signal communication with the magnetic sensor;
an acceleration sensor;
a second signal conditioning circuit in signal communication with the acceleration sensor;
a microprocessor in signal communication with the first and second signal conditioning circuits; and
a single electronic package configured to structurally support and to electrically interconnect, the sensors, the signal conditioning circuits, and the microprocessor in an integrated arrangement, wherein the sensors, the signal conditioning circuits, and the microprocessor interact to provide signal conditioning and compass computations.

2. The magnetic compass of claim 1 wherein the acceleration sensor includes at least two magnetic field sensing axes arranged for detecting magnetic field components.

3. The magnetic compass of claim 1 wherein the acceleration sensor includes three magnetic field sensing axes arranged substantially orthogonal to one another for detecting magnetic field components.

4. The magnetic compass of claim 1 wherein the acceleration sensor includes at least two acceleration sensing axes arranged to detect an acceleration.

5. The magnetic compass of claim 1 wherein the acceleration sensor includes three acceleration sensing axes arranged substantially orthogonal to one another for detecting an acceleration.

6. The magnetic compass of claim 1 wherein the second signal conditioning circuits are integrated.

7. The magnetic compass of claim 1, further comprising a temperature sensor attached to the package in signal communication with the microprocessor.

8. The magnetic compass of claim 1, wherein the temperature sensor is configured to provide temperature compensation to at least one of the sensed signals.

9. The magnetic compass of claim 1, wherein the single electronic package is made from the group consisting of plastic, silicon, and a laminate.

10. The magnetic compass of claim 1, wherein the first signal processing circuit is configured as an application-specific integrated circuit for processing signals from the magnetic sensor.

11. The magnetic compass of claim 1, wherein the second signal processing circuit is configured as an application-specific integrated circuit for processing signals from the acceleration sensor.

12. The magnetic compass of claim 1, wherein the single electronic package is constructed to enable integrating the magnetic compass, via surface mount technology, onto a next level assembly.

13. The magnetic compass of claim 1, wherein the single electronic package can be assembled vertically or horizontally, and in any orientation.

14. The magnetic compass of claim 1, wherein the microprocessor is operable to take a compass heading when the single electronic package is arranged in a desired orientation.

15. A method of arranging electrical components of a magnetic compass to produce compass-related computations, the method comprising:
structurally attaching a magnetic sensor, an acceleration sensor, and signal conditioning circuits onto a single electronic package;
centrally locating and structurally attaching a microprocessor on the package such that the microprocessor is in electrical communication with at least the signal conditioning circuits;
detecting a tilt angle of the compass with the acceleration sensor and providing a signal representative of the tilt angle to the microprocessor;
detecting a magnetic field with the magnetic sensor and providing a signal representative of the magnetic heading to the microprocessor; and
outputting a tilt angle and magnetic heading based on a detected tilt angle and magnetic heading of the compass.

16. The method of claim 15, wherein structurally attaching the magnetic sensor, the acceleration sensor, and the signal conditioning circuits onto the single electronic package includes using surface mount technology.

17. The method of claim 15, wherein outputting includes interfacing with a serial device via a data communication port.

18. The method of claim 15, wherein outputting includes performing temperature compensation based on a sensed temperature of the package.

19. The method of claim 15, further comprising sensing a temperature of the package with a temperature sensor located and coupled to the package.

20. The method of claim 15, further comprising sensing compensating sensor biases arising from attaching the magnetic compass onto a next level assembly.
